(19) United States
(12) Patent Application Publication
(10) Pub. No.: US 2006/0163890 A1
(43) Pub. Date: Jul. 27, 2006

(54) Grip assist and glove

(76) Inventor: Tosiki Namiki, Nagano (JP)

Correspondence Address: BACON & THOMAS, PLLC, 625 SLATERS LANE, FOURTH FLOOR, ALEXANDRIA, VA, 22314, US

(21) Appl. No.: 11/147,280

(22) Filed: Jun. 8, 2005

(30) Foreign Application Priority Data
Jan. 21, 2005 (JP) 2005-014314

(51) Int. Cl. B65G 7/12

(52) U.S. Cl. 294/25

(57) ABSTRACT

A grip assist includes a principal part that fits on at least one finger and a projection provided to the principal part. When, for example, the grip of a golf club is grasped with the grip assist fitted on at least one finger, high gripping power can be provided by the tightening force of the band part or the main body, thus stabilizing the swing course of the club. This prevents slackening of the grip during swing.

### BACKGROUND OF THE INVENTION

1. Field of the Invention

The present invention relates to a grip assist and a glove, and in particular, it relates to a grip assist and a glove useful for sports such as golf, tennis, and baseball.

2. Description of the Related Art

When hitting a ball with a golf club, a tennis racket, or a baseball bat and so on, it is necessary to prevent slacking of the grip or shifting of the angle of the wrist by continuing to grasp the grip at a constant strength to stabilize the swing course of the club, racket, or bat. Particularly on the impact of hitting a ball, the grip must be grasped with impact-resistant strength.

However, women who have weak grasping power cannot have a firm grip with strength sufficient to stabilize the swing course, and so the grip may be slackened or the angle of the wrist may be shifted, causing hindrance to progress.

In order to prevent the shift of the wrist during golf swing, there is proposed an assist that keeps the angle of the wrist constant by bringing a hard plate-like support into contact with the back to the wrist of the hand and tightly fixing a wrist fixing portion at the end of the back support to the wrist (for example, refer to Japanese Examined Utility Model Registration Application Publication No. 82466: Patent Document 1).

However, the assist described in Patent Document 1 can fix the angle of the wrist but has no function of reinforcing the grip, and so it is inevitable that the grip will be slackened on the impact of hitting a ball.

### SUMMARY OF THE INVENTION

The present invention has been made to solve the foregoing problems. Accordingly, it is an object of the invention to provide a grip assist, when hitting a ball with a golf club, a tennis racket, or a baseball bat and so on, capable of stabilizing the swing course, and on the impact of hitting a ball, preventing slackening of the grip or shifting of the angle of the wrist.

In order to achieve the above object, a grip assist according to a first aspect of the invention comprises a principal part to be fitted on at least one finger, and a projection provided to the principal part.

Preferably, in the grip assist, the principal part is a cylindrical main body, and the projection is integrated with the main body.

Preferably, in the grip assist, the principal part has a belt-like band part to be wound around a finger and a fixing means that is provided on both ends of the principal part and fixes the both ends to hold the finger, wherein the projection is formed when the fixing means holds the finger.

Preferably, in the grip assist, the band part is constructed so as to be wound around the middle finger and the third finger together.

Preferably, in the grip assist, the band part is constructed so as to be wound around the middle finger and the third finger separately.

Preferably, in the grip assist, the fixing means is a hook-and-loop fastener provided at both ends of the belt part.

Preferably, in the grip assist, the band part has an outer band part made of an elastic material and an inner band part that is integrally provided inside the outer band part and is made of an elastic material softer than the outer band part.

According to a second aspect of the invention, there is provided a glove comprising the grip assist.

With such a structure, the gripping power of the fist can be reinforced by tightening the fingers by the principal part that fits on at least one finger and the projection provided to the principal part. Thus, the gripping power of women who have a weak grip can be reinforced when they grasp a golf club, a tennis racket, or a baseball bat and so on. Accordingly, the swing course of the club, racket, or bat can be stabilized and also, on the impact of hitting a ball, the grip is not slackened or the angle of the wrist is not shifted by the impact, so that the flying direction of the ball can be stabilized. This prevents hindrance to progress of women who have a weak grip.

### BRIEF DESCRIPTION OF THE DRAWINGS

FIG. 1 is a general perspective view of a grip assist according to a first embodiment of the present invention;

FIG. 2 is an explanatory diagram showing a state in which the grip assist shown in FIG. 1 is fitted to fingers, as viewed from the palm of a hand;

FIG. 3 is an explanatory diagram showing a state in which the grip assist shown in FIG. 1 is fitted on fingers and the grip of a golf club is grasped;

FIG. 4 is an enlarged sectional view of a modification of the grip assist according to the first embodiment;

FIG. 5 is a general perspective view of a grip assist according to a second embodiment of the invention;

FIG. 6 is an explanatory diagram showing a state in which the grip assist shown in FIG. 5 is fitted on fingers, as viewed from the palm of a hand;

FIG. 7 is an explanatory diagram showing a state in which the grip assist shown in FIG. 5 is fitted on fingers and the grip of a golf club is grasped;

FIG. 8 is a schematic diagram of the inside of the middle finger and the third finger, which is increased in thickness to increase gripping force;

FIG. 9 is a schematic diagram of a normal grip state in which the outside of the fist is flat;

FIG. 10 is a schematic diagram showing a state in which the belt-like grip assist is fitted;

FIG. 11 is a schematic diagram showing a grip state in which the grip assist is fitted and the outside of the fist is round;

FIG. 12 is a schematic diagram of a grip assist according a third embodiment of the invention;

FIG. 13 is a schematic diagram in which the grip assist shown in FIG. 12 is fitted on one finger;

FIG. 14 is a schematic diagram in which the grip assist shown in FIG. 12 is fitted on five fingers;

FIG. 15 is a schematic diagram showing a state in which the grip assist shown in FIG. 12 is fitted in another way in which it is fitted on one finger; and

FIG. 16 is schematic diagram showing a state in which the grip assist shown in FIG. 12 is fitted in still another way in which it is fitted on four fingers.

### DESCRIPTION OF THE PREFERRED EMBODIMENTS

The present invention is described in detail below based on embodiments, with reference to the attached drawings.

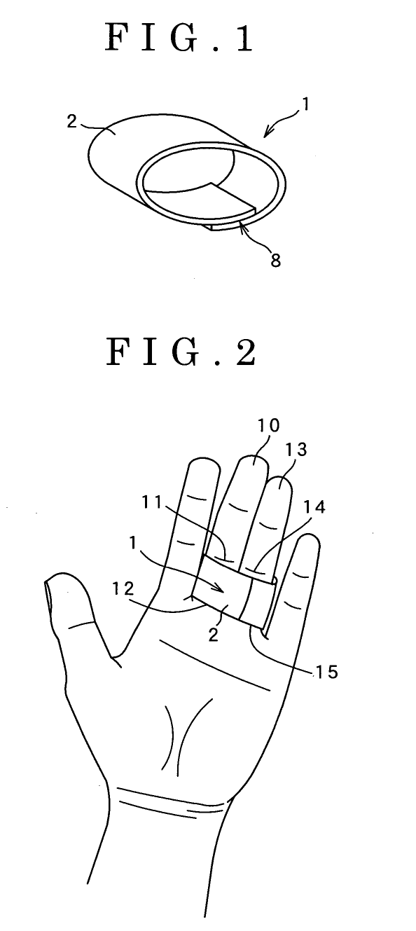

FIGS. 1 to 3 show a grip assist 1 according to a first embodiment of the invention. The grip assist 1 includes a belt-like band part 2 that is a principal part and a fixing means 8 that fixes the ends of the band part 2 to form a projection. Specifically, the grip assist 1 includes the band part 2 that is wound around a part between the second joint 11 and the third joint 12 of the middle finger 10 and a part between the second joint 14 and the third joint 15 of the third finger 13, and the fixing means 8 that fixes the band part 2 in such a manner that the band 2 is wound around a part between the second joint 11 and the third joint 12 of the middle finger 10 and a part between the second joint 14 and the third joint 15 of the third finger 13.

The band part 2 is an elastic belt that is wound around a part between the second joint 11 and the third joint 12 of the middle finger 10 and a part between the second joint 14 and the third joint 15 of the third finger 13 and has a length that allows the both ends to overlap with each other. The material of the band part 2 can be various rubbers or synthetic resins.

Referring to FIG. 4, the band part 2 may have a two-layer structure having an outer band part 3 and an inner band part 4 integrally provided inside the outer band part 3. In this case, when the inner band part 4 is formed of an elastic material softer than the outer band part 3, higher fitness can be provided. The inner band part 4 may have a plurality of projections 5 that project inward, with which the cushions (inner parts) of the middle finger and the third finger are brought into contact, so as to give impulse thereto. The shape of the projections 5 is not particularly limited, of which the surface is spherical in this embodiment.

As shown in FIG. 1, the fixing means 8 that form a projection is provided at both ends of the band part 2. With the fixing means 8, the band part 2 is bonded at the ends in such a way as to be wound around a part between the second joint 11 and the third joint 12 of the middle finger 10 and a part between the second joint 14 and the third joint 15 of the third finger 13. The fixing means 8 may be any that has the function of bonding or separating the both ends of the band part 2, such as a commercial hook-and-loop fastener (e.g., Magic tape: a trademark of Kuraray Co., Ltd). When the hook-and-loop fastener is used, the hook of the hook-and-loop fastener is provided at one end of the band part 2 and the loop is provided at the other end and as such, the both ends of the band part 2 can freely be bonded to and separated from each other.

As shown in FIG. 2, the band part 2 of the grip assist 1 according to the embodiment with such a structure is wound around a part between the second joint 11 and the third joint 12 of the middle finger 10 and a part between the second joint 14 and the third joint 15 of the third finger 13, and is firmly fixed thereto, with the both ends of the band part 2 overlapping each other with the fixing means 8 at the both ends.

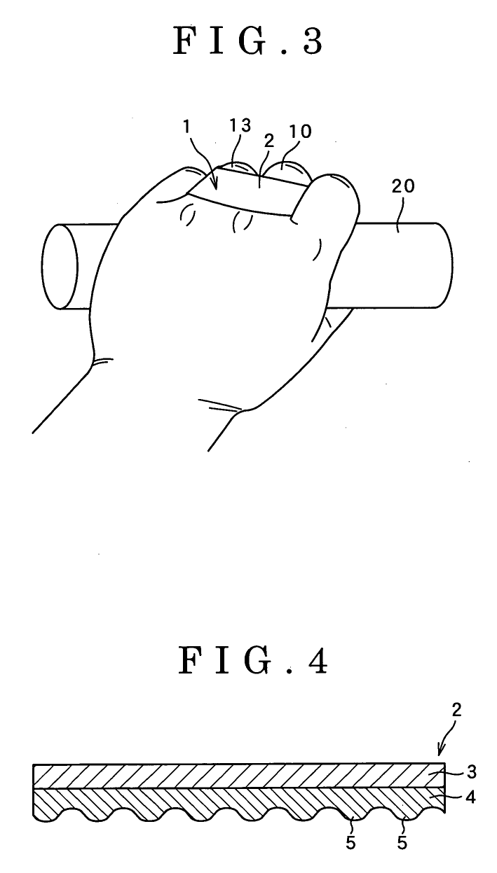

When, for example, the grip 20 of a golf club is grasped with the grip assist 1 fixed on the middle finger 10 and the third finger 13, as shown in FIG. 3, a force in the direction of increasing grasping power is applied to the back of the hand by the tightening force of the band part 2, so that the power to grasp the grip 20 is reinforced by the force.

Thus, when a club is swung, the swing course of the club can be stabilized. Also, on the impact of hitting a ball, slackening of the grip 20 and shifting of the wrist can be prevented, so that the flying direction of the ball can be stabilized.

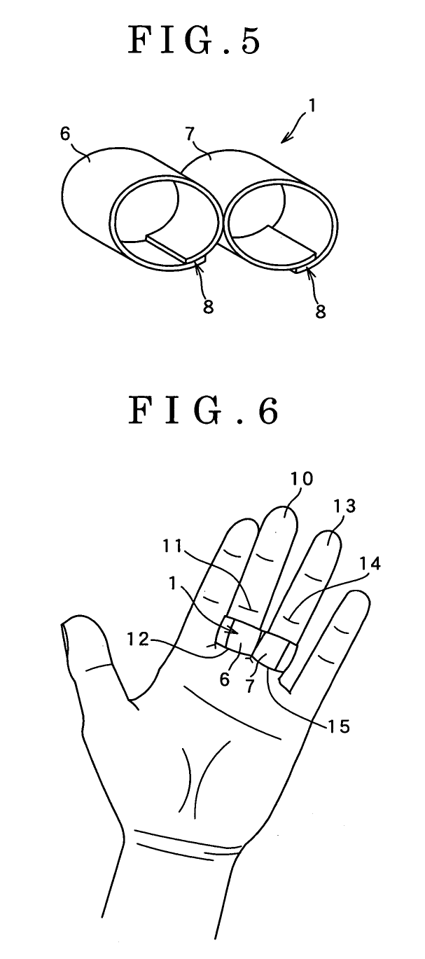

FIGS. 5 to 7 show a grip assist according to a second embodiment of the present invention. This grip assist 1 has two band parts 2. Specifically, the grip assist 1 includes a first band part 6 that is wound around a part between the second joint 11 and the third joint 12 of the middle finger 10 and a second band part 7 that is wound around a part between the second joint 14 and the third joint 15 of the third finger 13. The first band part 6 and the second band part 7 are bonded together with an adhesive or the like. The other structures are the same as those of the first embodiment.

In this case, the first band part 6 has the fixing means 8 (e.g., a hook-and-loop fastener) at the both ends, and the second band part 7 also has the fixing means 8 (e.g., a hook-and-loop fastener) at the both ends. The first band part 6 can be fixed with the fixing means 8 in such a manner as to tighten a part between the second joint 11 and the third joint 12 of the middle finger 10. The second band part 7 can be fixed with the fixing means 8 in such a manner as to tighten a part between the second joint 14 and the third joint 15 of the third finger 13.

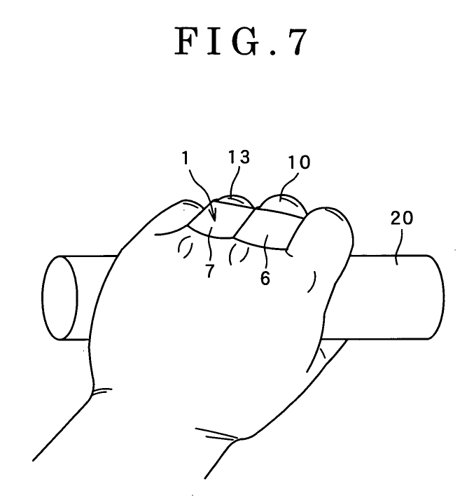

Also with the grip assist 1 according to the second embodiment, when, for example, the grip 20 of a golf club is grasped, as shown in FIG. 7, a force in the direction of increasing grasping power is applied to the back of the hand by the tightening force of the band part 2, so that the power to grasp the grip 20 is reinforced by the force, as in the first embodiment.

Thus, when a club is swung, the swing course of the club can be stabilized. Also, on the impact of hitting a ball, slackening of the grip 20 and shifting of the wrist can be prevented, so that the flying direction of the ball can be stabilized.

In the foregoing description, the grip assist 1 is wound directly around a part between the second joint 11 and the third joint 12 of the middle finger 10 and a part between the second joint 14 and the third joint 15 of the third finger 13. However, the position is not limited to those only when the inner parts of the middle finger 10 and the third finger 13 are made thick, and the position may be the entire-inner parts of the fingers 10 and 13. Although not shown, the grip assist 1 may be integrated with the inner surface of a glove with bonding or sewing means so that the glove on the hand can function as the grip assist 1.

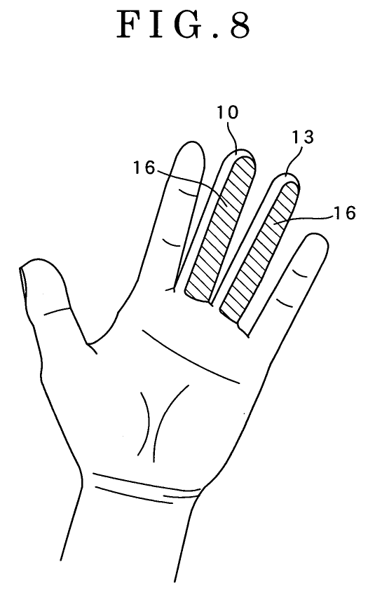

The reason why the foregoing grip assist 1 is useful is that it can prevent the wrist from shifting on impact by providing thickness 16 to the grasping surfaces of the middle finger 10 and the third finger 13, as shown in FIG. 8, to increase gripping power.

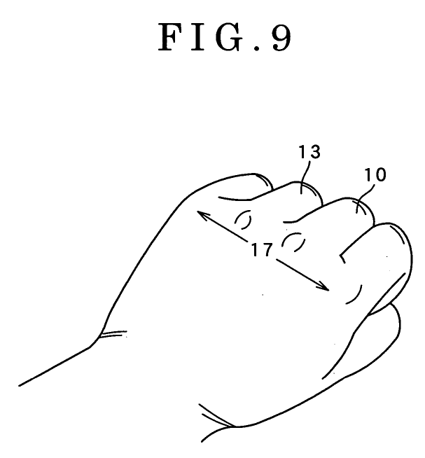

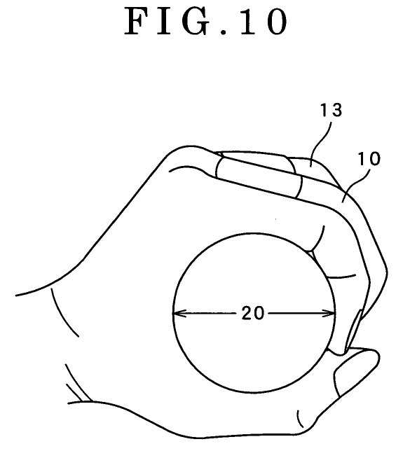

However, if the inner parts of the middle finger 10 and the third finger 13 are not thick, or in a normal state, the outside of the fist becomes flat 17 to generate normal gripping power, as shown in FIG. 9, and in this state, an impact will be given.

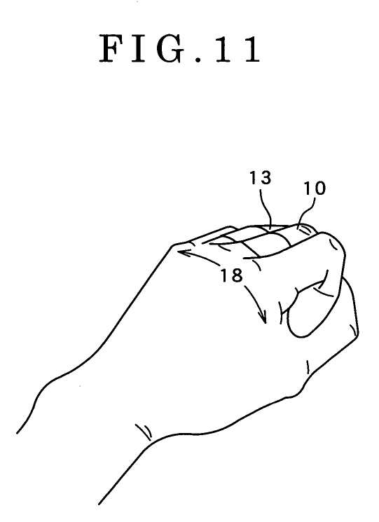

On the other hand, when the grasping surfaces (the inside) of the middle finger 10 and the third finger 13 are provided with the thickness 16 as described with reference to FIG. 8, the gripping power is increased to prevent the shift on impact. For example, when the belt-like grip assist is fitted as shown in FIG. 10, the inside of the middle finger 10 and the third finger 13 becomes thick and so the wrist is fixed, with the outside of the fist in round shape 18, as shown in FIG. 11, preventing the wrist from moving on impact. In other words, making the inside of the middle finger 10 and the third finger 13 thick increases pressure to the inside of the fingers, thereby increasing the holding power. Accordingly, high gripping power can be provided in a natural grip state by increasing the thickness of the middle finger 10 and the third finger 13, so that the wrist can be fixed on impact.

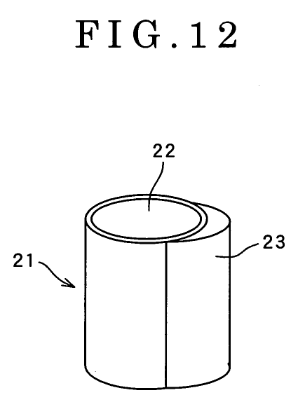

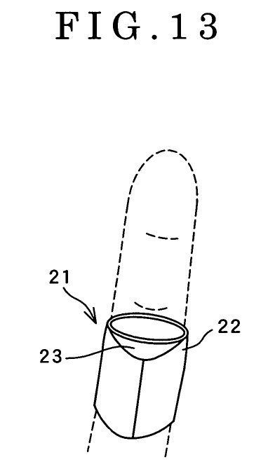

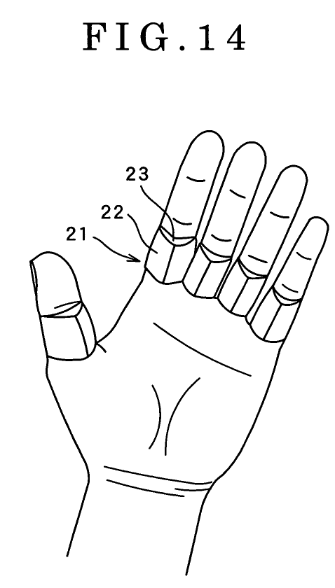

FIGS. 12 to 14 show a grip assist 21 according to a third embodiment of the invention. FIG. 12 is a schematic diagram of the grip assist 21; FIG. 13 is a schematic diagram showing a state in which the grip assist 21 is fitted on one finger; and FIG. 14 is a schematic diagram showing a state in which the grip assist 21 is fitted on five fingers. The grip assist 21 has a specified width and includes a main body 22 that is a principal part to be fitted on a finger and a projection 23 with a length the same as the width of the main body 22 and provided on one side of the main body 22. FIG. 13 shows a state in which the projection 23 projects inside the palm. FIG. 14 shows the grip assist 21 fitted on five fingers, of which each projection 23 projects inside the palm.

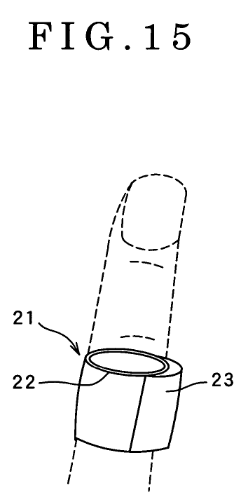

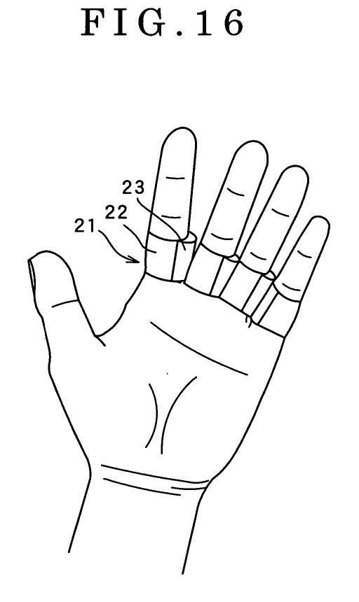

FIGS. 15 and 16 show a state in which the grip assist 21 shown in FIG. 12 is fitted in another way, in which it is fitted on at least one of four finger except a thumb, FIG. 15 showing a state in which the grip assist 21 is fitted on one finger, and FIG. 16 showing a state in which the second grip 21 is fitted on four fingers. In those fitted states, the grip assist 21 is fitted on the finger(s), with the projection 23 projecting to the adjacent finger.

In this case, when the grip assist 21 is fitted on the index finger and the little finger, the projection 23 projects to the middle finger and the third finger, respectively. When it is fitted on the four fingers, the projections 23 sometimes overlap with each other between the index finger and the middle finger and between the third finger and the little finger, in which case, however, there is no problem in use.

Locating the projection 23 on the inside or on the side of the finger provides high gripping power as in the foregoing embodiments, allowing the wrist to be fixed on impact.

While the invention has been described with reference to the embodiments in which a belt-like band part is wound as a principal part and a cylindrical main body with a specified width is fitted, it is to be understood that the grip assist has only to be wound around at least one finger and is not limited to the belt-like or cylindrical shape.

1. A grip assist comprising:
a belt-like band part to be wound around at least one finger;
a a fixing means provided on a surface of a first end of the band and on an opposite surface of a second end of the band to fix both ends to hold the finger.

2. (canceled)

3. (canceled)

4. The grip assist according to claim 1, wherein the band part is constructed so as to be wound around the middle finger and the third finger together.

5. The grip assist according to claim 1, wherein the band part is constructed so as to be wound around the middle finger and the third finger separately.

6. The grip assist according to claim 1, wherein the band part has an outer band part made of an elastic material and an inner band part that is integrally provided inside the outer band part and is made of an elastic material softer than the outer band part.

7. The grip assist according to claim 4, wherein the band part has an outer band part made of an elastic material and an inner band part that is integrally provided inside the outer band part and is made of an elastic material softer than the outer band part.

8. (canceled)

9. A grip assist comprising:
a cylindrical main body part to be fitted on at least one finger; and a projection integrated with the main body.
